(19) United States
(12) Patent Application Publication
(10) Pub. No.: US 2014/0009711 A1
(43) Pub. Date: Jan. 9, 2014

(54) LIQUID CRYSTAL DISPLAY DEVICE

(71) Applicant: Japan Display Inc., Tokyo (JP)

(72) Inventors: Yasushi TOMIOKA, Hitachinaka-shi (JP); Chikae MATSUI, Mobara-shi (JP); Noboru KUNIMATSU, Chiba-shi (JP); Hidehiro SONODA, Mobara-shi (JP)

(21) Appl. No.: 13/930,112

(22) Filed: Jun. 28, 2013

(30) Foreign Application Priority Data
Jul. 4, 2012 (JP) 2012-150312

(51) Int. Cl. G02F 1/1343

(52) U.S. Cl. CPC G02F 1/134363
USPC 349/43; 349/138; 349/123

(57) ABSTRACT

A liquid crystal display device in a lateral electric field mode includes: a metal wiring formed on a transparent substrate; an inorganic insulating film and an organic insulating film formed on the metal wiring; and a first transparent electrode and a second transparent electrode formed on the inorganic insulating film and the organic insulating film so that the first and the second transparent electrodes are opposite to each other through an interlayer insulating film. The film thickness of the organic insulating film on the metal wiring is made thicker than the film thickness of the organic insulating film inside a pixel display region including the contact hole, and a projecting portion of the organic insulating film is formed on the metal wiring. A pixel electrode formed of the first electrode or the second electrode is formed on an image display region including a slope portion of the projecting portion.

### CLAIM OF PRIORITY

The present application claims priority from Japanese Patent Application JP2012-150312 filed on Jul. 4, 2012, the content of which is hereby incorporated by reference into this application.

### BACKGROUND OF THE INVENTION

1. Field of the Invention

The present invention relates to a lateral electric field mode liquid crystal display device.

2. Description of the Related Art

In liquid crystal display devices, in order to implement a wide viewing angle, for example, an IPS (In-Plane Switching) mode liquid crystal display device is developed in which the behavior of liquid crystals is controlled in a plane using a lateral electric field or a fringing field.

In the IPS mode liquid crystal display device, in order to improve an aperture ratio and to achieve a high definition, a common electrode is formed so as to cover a data line. However, when the data line is covered with the common electrode, the parasitic capacitance between the common electrode and the data line is increased to cause a problem.

Japanese Patent Application Laid-Open Publication No. 2004-302448 describes a liquid crystal display device including a first substrate having a thin film transistor, a data line, a pixel electrode, and a common electrode, a second substrate, and liquid crystals sandwiched between the first substrate and the second substrate. An image signal is applied to the thin film transistor through the data line. An electric field is produced across the common electrode and the pixel electrode received with the image signal. The electric field rotates the liquid crystals in a plane parallel with the first substrate. The first substrate includes an inorganic insulating film covering the data line, a projecting organic insulating film provided on the inorganic insulating film above the data line, and a shield common electrode covering the organic insulating film and covering the data line when seen from above (claim 1).

Moreover, Japanese Patent Application Laid-Open Publication No. 2009-192932 describes an IPS mode liquid crystal display device using a fringing field in which a projecting organic film is formed so as to cover a source wiring in order to reduce parasitic capacitance, the projecting organic film extends between adjacent pixel electrodes along the source interconnection, and a counter electrode is formed on the organic film so as to cover the source wiring (see a second embodiment).

### SUMMARY OF THE INVENTION

Japanese Patent Application Laid-Open Publication No. 2004-302448 describes the projecting organic insulating film formed to reduce the parasitic capacitance between an wiring and an upper electrode. However, only the IPS mode liquid crystal display device is described in which both of the pixel electrode and the common electrode are comb teeth electrodes. It is insufficient that a region near the end portion of the wiring is used as a transmission region.

Furthermore, Japanese Patent Application Laid-Open Publication No. 2009-192932 describes the IPS mode liquid crystal display device using a fringing field in which the projecting organic insulating film is formed on the wiring in order to reduce the parasitic capacitance. However, since no pixel electrode is formed on the organic insulating film, it is insufficient that a region near the end portion of the wiring is used as a transmission region.

In addition, in both of Japanese Patent Application Laid-Open Publication No. 2004-302448 and Japanese Patent Application Laid-Open Publication No. 2009-192932, excellent rubbing orientation processing is not performed on a region near a step of the projecting organic insulating film because of the step, and light leaks due to the disturbance of orientation of liquid crystals. Since a light shielding portion (a black matrix, for example) is provided in order to prevent a reduction in contrast caused by the light leakage, an aperture ratio and a transmittance are reduced.

It is an object of the present invention is to solve the problems, and to provide a liquid crystal display device in a lateral electric field mode that improves a pixel aperture ratio and a transmittance.

In order to solve the problems an example of a liquid crystal display device according to the present invention is a liquid crystal display device in a lateral electric field mode including: a metal wiring formed on a transparent substrate; an inorganic insulating film and an organic insulating film formed on the metal wiring; and a first transparent electrode and a second transparent electrode having a stripe slit structure formed on the inorganic insulating film and the organic insulating film so that the first transparent electrode and the second transparent electrode are opposite to each other through an interlayer insulating film. Liquid crystals are driven by applying an electric field across the first electrode and the second electrode. An output from a thin film transistor is electrically connected to the first transparent electrode or the second electrode through a contact hole penetrating through the inorganic insulating film or the organic insulating film. A film thickness of the organic insulating film on the metal wiring is made thicker than a film thickness of the organic insulating film on a pixel display region including the contact hole, and a projecting portion of the organic insulating film is formed on the metal wiring. A pixel electrode formed of the first electrode or the second electrode is formed on an image display region including a slope portion of the projecting portion.

In the liquid crystal display device according to the present invention, preferably, the metal wiring is any one of a drain wiring and a gate wiring or both of the drain wiring and the gate wiring.

Moreover, in the liquid crystal display device according to the present invention, preferably, the organic insulating film is not formed on a contact hole formed at least on the pixel display region.

Furthermore, in the liquid crystal display device according to the present invention, preferably, an area of the covering organic insulating film formed at least on the pixel display region is 50% or less of an area of the display region.

In addition, in the liquid crystal display device according to the present invention, preferably, an alignment layer is provided on the second transparent electrode or the first transparent electrode, and the alignment layer is an optical alignment layer.

Moreover, in the liquid crystal display device according to the present invention, preferably, a terminal end portion of a slit of the second transparent electrode is formed on the organic insulating film.

Furthermore, in the liquid crystal display device according to the present invention, preferably, the second transparent electrode is not overlapped with the first transparent electrode immediately below at the terminal end portion of the stripe slit of the second transparent electrode.

In addition, in the liquid crystal display device according to the present invention, preferably, a tilt angle of the projecting portion of the organic insulating film on the metal wiring is an angle of 10 degrees or more and an angle of 75 degrees or less, more preferably, an angle of 10 degrees or more and an angle of 50 degrees or less.

Moreover, in the liquid crystal display device according to the present invention, preferably, the organic insulating film on the metal wiring is colored.

Furthermore, in the liquid crystal display device according to the present invention, preferably, the first transparent electrode is a pixel electrode, and a second electrode having a stripe slit structure is a common electrode.

In addition, in the liquid crystal display device according to the present invention, preferably, a transparent common electrode having a stripe slit structure is formed in a direction nearly orthogonal to a drain wiring, a slit end portion is not disposed on a green pixel, and a terminal end portion of a slit is formed on a drain line adjacent to a blue pixel and a red pixel.

Moreover, in the liquid crystal display device according to the present invention, preferably, the first transparent electrode is a common electrode, and the second electrode having a stripe slit structure is a pixel electrode.

Furthermore, in the liquid crystal display device according to the present invention, preferably, a light shielding portion is not formed between adjacent pixels at a location on a counter substrate corresponding to the projecting portion of the organic insulating film.

In addition, in the liquid crystal display device according to the present invention, preferably, a projecting cylindrical spacer is formed on a counter substrate side so that the projecting cylindrical spacer is overlapped with the projecting portion of the organic insulating film on a TFT substrate, and a cell gap of a liquid crystal layer is held using the projecting portion of the organic insulating film and the cylindrical spacer.

Moreover, in the liquid crystal display device according to the present invention, preferably, at the location on the organic insulating film on the TFT substrate corresponding to the projecting cylindrical spacer, a base recess formed of a hollow or a groove is formed so that the projecting cylindrical spacer is filled in the base recess.

Furthermore, in the liquid crystal display device according to the present invention, preferably, a structure is provided in which the organic insulating film is formed in a bank shape throughout an outer edge of a display region to entirely surround the display region.

In addition, in the liquid crystal display device according to the present invention, preferably, a width of the organic insulating film formed in a bank shape throughout the outer edge is wider than a width of the projecting portion of the organic insulating film in the display region.

According to the present invention, it is possible to provide a liquid crystal display device in a lateral electric field mode that improves a pixel aperture ratio and a transmittance.

Moreover, it is possible that the leakage of a liquid crystal domain to the adjacent pixel is suppressed, which can in turn suppress color mixing, and that a black matrix is formed in narrow lines.

### BRIEF DESCRIPTION OF THE DRAWINGS

The present invention will become fully understood from the detailed description given hereinafter and the accompanying drawings, wherein:

FIG. 1 is a cross sectional view of a single pixel of a liquid crystal display device according to a first embodiment of the present invention;

FIG. 2A is a plan view of the single pixel of the liquid crystal display device according to the first embodiment of the present invention;

FIG. 2B is a plan view of the single pixel of the liquid crystal display device according to the first embodiment of the present invention;

FIG. 3 is a cross sectional view of a single pixel of a liquid crystal display device according to a second embodiment of the present invention;

FIG. 4A is a plan view of the single pixel of the liquid crystal display device according to the second embodiment of the present invention;

FIG. 4B is a plan view of the single pixel of the liquid crystal display device according to the second embodiment of the present invention;

FIG. 5 is a cross sectional view of a single pixel of a liquid crystal display device according to a third embodiment of the present invention;

FIG. 6A is a plan view of the single pixel of the liquid crystal display device according to the third embodiment of the present invention;

FIG. 6B is a plan view of the single pixel of the liquid crystal display device according to the third embodiment of the present invention;

FIG. 7 is a cross sectional view of a single pixel of a liquid crystal display device according to a fourth embodiment of the present invention;

FIG. 8A is a plan view of the single pixel of the liquid crystal display device according to the fourth embodiment of the present invention;

FIG. 8B is a plan view of the single pixel of the liquid crystal display device according to the fourth embodiment of the present invention;

FIG. 9 is a plan view of the vicinity of the boundary of an adjacent pixel of a liquid crystal display device according to a fifth embodiment of the present invention;

FIG. 10 is a cross sectional view of the vicinity of the boundary of an adjacent pixel of the liquid crystal display device according to the fifth embodiment of the present invention;

FIG. 11A is a cross sectional view of a single pixel of a liquid crystal display device according to a sixth embodiment of the present invention;

FIG. 11B is a cross sectional view of a single pixel of the liquid crystal display device according to the sixth embodiment of the present invention;

FIG. 12 is a plan view of the single pixel of the liquid crystal display device according to the sixth embodiment of the present invention;

FIG. 13 is a plan view of the corner of the display area of a liquid crystal display device according to a seventh embodiment of the present invention;

FIG. 14 is a cross sectional view of a single pixel of a conventional liquid crystal display device; and

FIG. 15 is a plan view of a single pixel of the conventional liquid crystal display device.

### DETAILED DESCRIPTION OF THE INVENTION

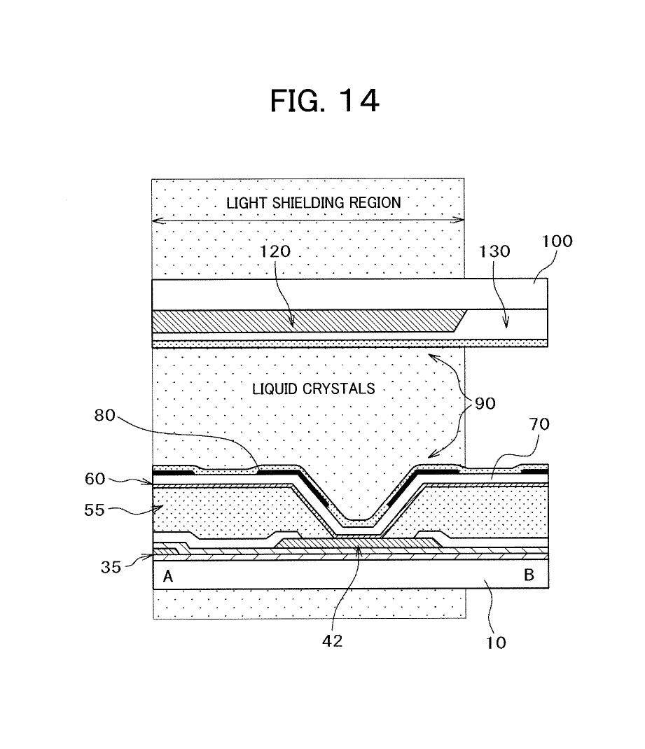

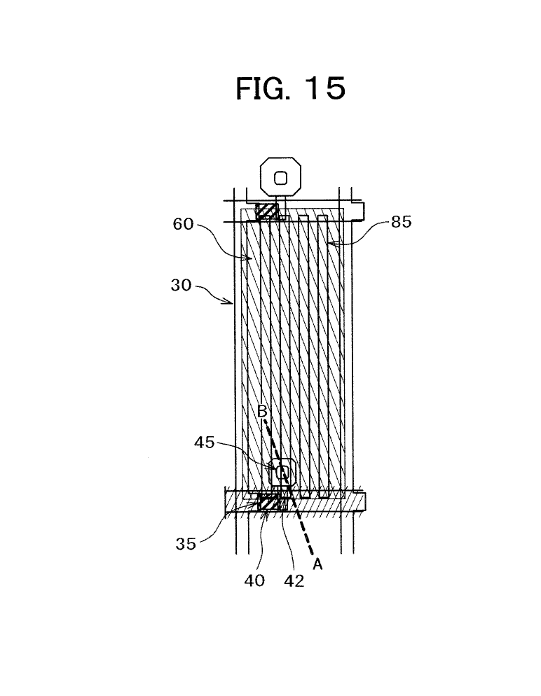

First, prior to describing an embodiment of the present invention, an example of a conventional liquid crystal display device will be described with reference to FIGS. 14 and 15. FIG. 15 is a plan view of a single pixel of a liquid crystal display device, and FIG. 14 is a cross sectional view along a line A-B in FIG. 15.

As illustrated in FIG. 15, in the liquid crystal display device, a plurality of drain wirings (or source wirings) 30 in parallel with each other and a plurality of gate wirings 35 in parallel with each other are formed so as to intersect with each other. A region surrounded by the drain wirings 30 and the gate wirings 35 adjacent to each other forms a single pixel. The drain wiring 30 and the gate wiring 35 are electrically connected to a thin film transistor (TFT) 40 provided on the corner of the pixel. Therefore, a plurality of the pixels each connected to the TFT is disposed in a matrix configuration on a TFT substrate 10.

In FIG. 14, the gate wiring 35 is formed on the TFT substrate 10 through an insulating film. A source electrode 42 is formed on the gate wiring 35 through an insulating film. It is noted that the drain wiring 30, not shown, is also formed on the same surface of the source electrode 42. An inorganic insulating film is formed on the source electrode 42, and an organic insulating film 55 having a predetermined film thickness is formed on the inorganic insulating film. After the formation, a contact hole 45 is formed on the inorganic insulating film and the organic insulating film 55 for electrical connection to the source electrode 42. A pixel electrode 60 is formed on the organic insulating film 55, and is electrically connected to the source electrode 42 at the contact hole 45. A common electrode 80 including a stripe slit 85 is formed on the pixel electrode 60 through an interlayer insulating film 70. An alignment layer 90 is applied on the common electrode 80, and the alignment layer 90 is formed by rubbing, for example.

On the other hand, a color resist layer (not shown), a black matrix 120, and an overcoat layer 130 are formed on a counter substrate (a color filter substrate) 100, and an alignment layer 90 is formed on the overcoat layer 130.

The TFT substrate 10 and the counter substrate 100 are disposed in a predetermined gap as sandwiching a liquid crystal layer. A drive electric field is then formed across the pixel electrode 60 and the counter electrode 80 to drive liquid crystals for display.

In the liquid crystal display device shown in FIG. 14, since the organic insulating film 55 having a thick film thickness is formed on the contact hole 45, the area of the contact hole 45 is increased. Since it is difficult to form an excellent alignment layer on the contact hole 45 by rubbing, light is leaked due to the disturbance of orientation of liquid crystals on the contact hole 45, for example. In order to prevent the light leakage and to shield the contact hole 45, it is necessary to increase the area of the source electrode 42 as a light shielding metal or to form the black matrix 120. As described above, in the conventional liquid crystal display device, the light shielding region of the contact hole is increased, the pixel aperture ratio is reduced, and the transmittance is restricted. Moreover, at the end portion of the stripe slit of the common electrode 80 (the end portion of the comb teeth electrode), a reverse rotation domain of liquid crystals is produced to cause a non-transmission region on the boundary of a normal rotation portion, causing a reduction in the transmittance.

Next, embodiments of the present invention will be described with reference to the drawings. In the drawings, the same components are designated the same reference numerals and signs for omitting the repeated description.

### First Embodiment

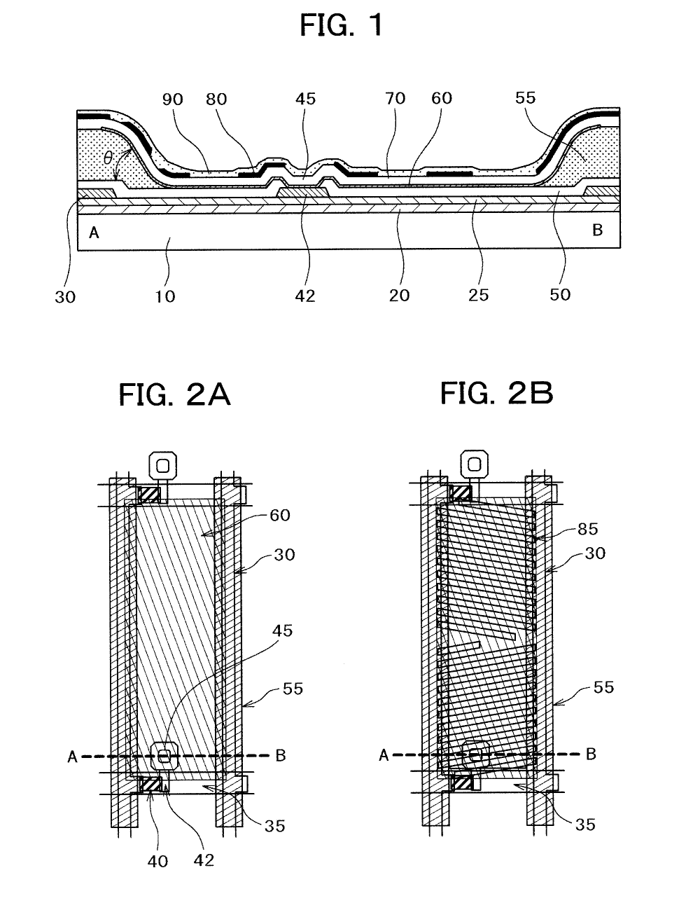

FIG. 1 and FIGS. 2A and 2B illustrate a liquid crystal display device according to a first embodiment. FIGS. 2A and 2B are plan views of a single pixel, and FIG. 1 is a cross sectional view of the single pixel along a line A-B in FIGS. 2A and 2B. In FIGS. 2A and 2B, FIG. 2A is a plan view of a drain wiring and a gate wiring to a pixel electrode, and FIG. 2B is a plan view of the drain wiring to a common electrode of the topmost layer. The first embodiment is an embodiment in which an organic insulating film on the drain wiring is left and most of the organic insulating film inside a pixel is removed.

In FIG. 1, an insulating film 20 and an insulating film 25 are formed on a TFT substrate 10 made of transparent glass, and a drain wiring 30 and a source electrode 42 of a TFT 40 are formed on the insulating film 25. It is noted that as illustrated in FIGS. 2A and 2B, a gate wiring 35 is formed between the insulating film 20 and the insulating film 25.

An inorganic insulating film 50 is formed on the drain wiring 30 and the source electrode 42 throughout the surface. On the inorganic insulating film 50, a projecting organic insulating film 55 is then formed on the drain wiring 30 in the direction of extending the drain wiring 30 in order to increase a distance to the drain wiring and to reduce coupling. The thickness of the organic insulating film 55 is about 1.5 μm, for example. The organic insulating film 55 is formed in such a way that an organic insulating film is formed throughout the surface, for example, the organic insulating film on a display area including a contact hole 45 is removed, and then the organic insulating film 55 is formed only on the drain wiring 30. The organic insulating film 55 is patterned and left, and then annealed, so that a tilt angle θ at the end portion of the organic insulating film 55 is controlled at an angle of about 50 degrees as illustrated in FIG. 1, for example. Preferably, the tilt angle θ at the end portion of the organic insulating film 55 is an angle of 10 degrees or more and an angle of 75 degrees or less, more preferably, an angle of 10 degrees or more and an angle of 50 degrees or less. It is noted that in the case where the slope of the end portion of the organic insulating film has an S-shaped cross section, an angle formed between the middle portion of the slope and the substrate surface may be set to the tilt angle θ.

On the inorganic insulating film 50 on the source electrode 42, a hole is formed to provide the contact hole 45 on the source electrode.

On the inorganic insulating film 50 in the display region and on the slope portion of the organic insulating film 55, a transparent pixel electrode (a first electrode) 60 is formed. The pixel electrode 60 is then electrically connected to the source electrode 42 through the contact hole 45. Moreover, the pixel electrode 60 is also formed on the organic insulating film 55, and patterned in a gap of about 2 μm to an adjacent pixel electrode on a boundary portion to an adjacent pixel on the drain wiring 30.

An interlayer insulating film 70 is formed on the pixel electrode 60. The interlayer insulating film 70 is made of an inorganic film having a uniform thickness of about 300 nm. A transparent common electrode (a second electrode) 80 including a stripe slit 85 in a width of 3 μm is formed on the interlayer insulating film 70. The end portion of the stripe slit 85 of the common electrode 80 (the end portion of a comb teeth electrode) is located on the projecting portion of the organic insulating film 55. Moreover, an alignment layer 90 is applied to the common electrode 80 throughout the surface, and the alignment layer 90 is formed by optical alignment, for example. The optical alignment layer 90 is used, so that liquid crystals can be excellently oriented also on the slope portion of the organic insulating film 55 and the step portion of the contact hole 45, and these portions can also be used as a display region.

As illustrated in FIG. 2A, the organic insulating film 55 is formed on the drain wiring 30, and the pixel electrode 60 is formed on the flat portion including the contact hole 45 and on the slope portion of the organic insulating film 55, so that the display region is formed. Moreover, as illustrated in FIG. 2B, the stripe slit 85 of the common electrode 80 is formed up to the projecting portion of the organic insulating film 55 so as to overlap with the pixel electrode 60. In FIGS. 2A and 2B, a reference numeral 35 denotes the gate wiring, and a reference numeral 40 denotes a TFT. For the TFT, the TFT may be any of an aSi-TFT, low-temperature polysilicon, and an indium gallium zinc oxide (IGZO) TFT. Furthermore, the organic insulating film 55 may be colored. In this case, color mixing from the adjacent pixel can be prevented.

It is noted that an example is desired in the embodiment in which the organic insulating film 55 is formed on the drain wiring 30 and most of the organic insulating film 55 on the flat portion between the drain wirings 30 is removed. However, it is apparent that an equivalent effect is obtained when the film thickness of the organic insulating film 55 on the drain wiring 30 is made thicker than the film thickness of the organic insulating film 55 on the flat portion between the drain wirings 30. However, it is preferable that the film thickness of the organic insulating film 55 on the portion near the contact hole 45 be thin as thin as possible. Preferably, it is desirable that the organic insulating film 55 be not formed on the contact hole 45. For example, a sufficient effect is obtained when the area of the covering organic insulating film 55 occupied on the display region is 50% or less.

According to the embodiment, conventionally, the organic insulating film is provided throughout the surface. On the contrary, the organic insulating film on the display region including the contact hole is removed, so that the area of the contact hole can be reduced. Accordingly, the light shielding area of the contact hole can be reduced, the pixel aperture ratio can be increased, and the transmittance can be improved.

Moreover, the organic insulating film is left on the wiring region of the drain wiring, that is, the organic insulating film is left on the boundary region, so that the gap of the pixel boundary is narrowed, and the leakage of liquid crystals from the liquid crystal domain to the pixel adjacent to the domain caused by the elasticity effect of liquid crystals is suppressed. Thus, color mixing with the adjacent pixel can be suppressed, and a black matrix BM provided on the color filter substrate can be formed in narrow lines, which in turn enables the deletion of the black matrix BM.

Furthermore, a gap is narrowed on the comb teeth end portion, that is, a gap is narrowed on the end portion of the stripe slit of the common electrode, so that a reduction in the transmittance caused by the reverse rotation domain of liquid crystals on the end portion of the comb teeth electrode can be suppressed.

### Second Embodiment

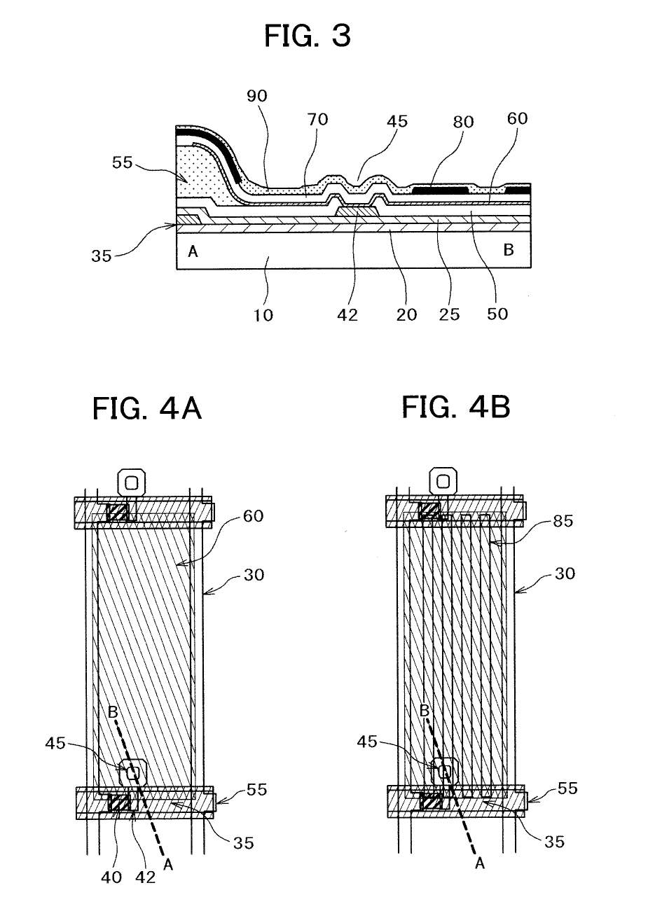

FIG. 3 and FIGS. 4A and 4B illustrate a liquid crystal display device according to a second embodiment. FIGS. 4A and 4B are plan views of a single pixel, and FIG. 3 is a cross sectional view of the single pixel along a line A-B in FIGS. 4A and 4B. In FIGS. 4A and 4B, FIG. 4A is a plan view of a drain wiring and a gate wiring to a pixel electrode, and FIG. 4B is a plan view of the drain wiring to a common electrode of the topmost layer. The second embodiment is an embodiment in which an organic insulating film on the gate wiring is left and most of the organic insulating film inside a pixel is removed.

In the embodiment, in FIG. 4A, an organic insulating film 55 having a film thickness of about 2 μm is patterned and left above a gate wiring 35 formed in the lateral direction for annealing, so that a tilt angle of the end portion of the organic insulating film 55 is formed at an angle of about 40 degrees, for example. On the organic insulating film 55, a transparent pixel electrode (a first electrode) 60 is provided so as to be electrically connected to a source electrode 42 of a TFT through a contact hole 45. An interlayer insulating film 70 made of an inorganic film having a uniform thickness of about 200 nm is formed on the pixel electrode, and a transparent common electrode (a second electrode) 80 including a stripe slit 85 in a width of 3 μm is formed on the interlayer insulating film 70. In the embodiment, as illustrated in FIG. 4B, the stripe slit 85 of the common electrode 80 is formed in such a way that the end portion of the slit 85 is located on the slope portion of the organic insulating film 55 in the vertical direction.

Also in the embodiment, as similar to the first embodiment, the film thickness of the organic insulating film on the display region including the contact hole is reduced, or preferably the organic insulating film removed, so that the area of the contact hole can be reduced. Accordingly, the light shielding area of the contact hole can be reduced, the pixel aperture ratio can be increased, and the transmittance can be improved.

Moreover, the organic insulating film is left on the wiring region of the gate wiring, that is, the organic insulating film is left on the boundary region, so that the gap of the pixel boundary is narrowed, and the leakage of liquid crystals from the liquid crystal domain to the pixel adjacent to the domain caused by the elasticity effect of liquid crystals is suppressed. Thus, color mixing with the adjacent pixel can be suppressed, and a black matrix BM provided on a color filter substrate can be formed in narrow lines, which in turn enables the deletion of the black matrix BM.

Furthermore, a gap is narrowed on the comb teeth end portion, that is, a gap is narrowed on the end portion of the stripe slit of the common electrode, so that a reduction in the transmittance caused by the reverse rotation domain of liquid crystals on the end portion of the comb teeth electrode can be suppressed.

### Third Embodiment

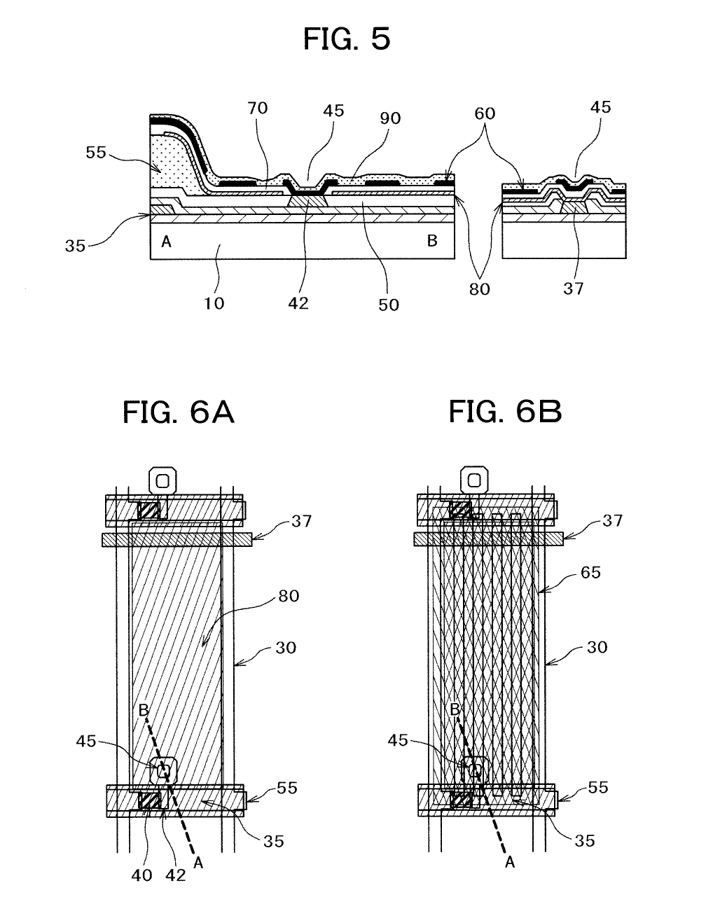

FIG. 5 and FIGS. 6A and 6B illustrate a liquid crystal display device according to a third embodiment. FIGS. 6A and 6B are plan views of a single pixel, and FIG. 5 is a cross sectional view of the single pixel along a line A-B in FIGS. 6A and 6B. FIG. 6A is a plan view of a drain wiring and a gate wiring to a common electrode, and FIG. 6B is a plan view of the drain wiring to a pixel electrode of the topmost layer. The third embodiment is an embodiment in which an organic insulating film on the gate wiring is left and most of the organic insulating film inside a pixel is removed.

In the third embodiment, as illustrated in FIGS. 6A and 6B, a common electrode wiring 37 is included in the lateral direction, and is electrically connected to the common electrode through a contact hole. As similar to the second embodiment, an organic insulating film 55 having a film thickness of about 2 μm is patterned and left above a gate wiring 35 for annealing, so that a tilt angle θ at the end portion of the organic insulating film 55 is formed at an angle of about 40 degrees. On the organic insulating film 55, a transparent common electrode 80 is electrically connected to the common electrode wiring 37 through a contact hole 45. The common electrode 80 is patterned in a gap of about 3 μm to the adjacent common electrode on the boundary portion to the adjacent pixel on the gate wiring 35. An interlayer insulating film 70 made of an inorganic film having a uniform thickness of about 200 nm is formed on the common electrode 80, and a transparent pixel electrode 60 including a stripe slit 65 in a width of 3 μm is formed on the interlayer insulating film 70. The pixel electrode 60 is electrically connected to a source electrode 42 of a TFT through a contact hole 45.

Also in the embodiment, as similar to the first embodiment, the organic insulating film 55 on the display region including the contact hole 45 connected to the common electrode wiring 37 and the contact hole 45 connected to the source electrode 42 is removed, so that the areas of the contact holes 45 can be reduced. Accordingly, the light shielding areas of the contact holes can be reduced, the pixel aperture ratio can be increased, and the transmittance can be improved.

Moreover, the organic insulating film is left on the wiring region of the gate wiring, that is, the organic insulating film is left on the boundary region, so that the gap of the pixel boundary is narrowed, and the leakage of liquid crystals from the liquid crystal domain to the pixel adjacent to the domain caused by the elasticity of liquid crystals is suppressed. Thus, color mixing with the adjacent pixel can be suppressed, and a black matrix BM can be formed in narrow lines provided on a color filter substrate.

In addition, a gap is narrowed on the comb teeth end portion, that is, a gap is narrowed on the end portion of the stripe slit of the pixel electrode, so that a reduction in the transmittance caused by the reverse rotation domain of liquid crystals on the end portion of the comb teeth electrode can be suppressed.

### Fourth Embodiment

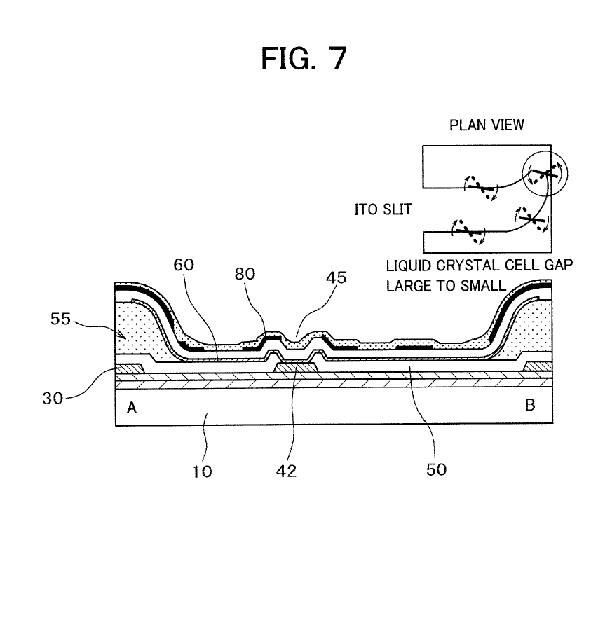

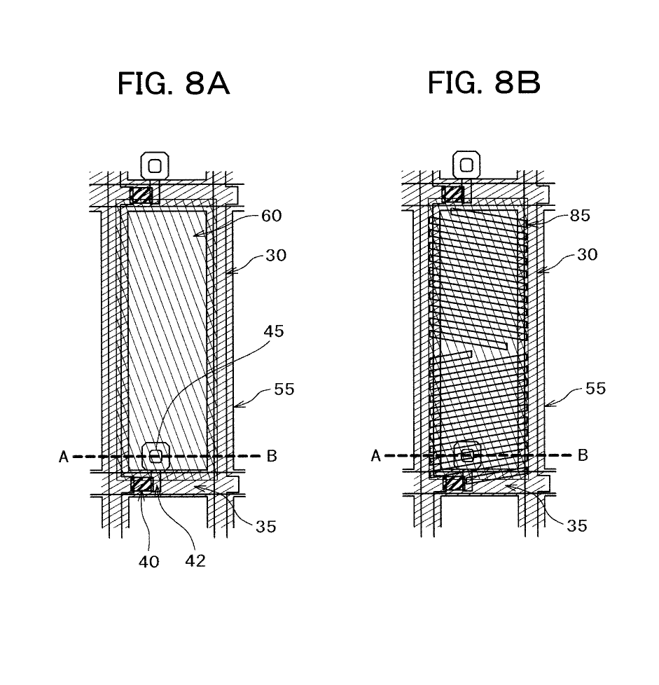

FIG. 7 and FIGS. 8A and 8B illustrate a liquid crystal display device according to a fourth embodiment. FIGS. 8A and 8B are plan views of a single pixel, and FIG. 7 is a cross sectional view of the single pixel along a line A-B in FIGS. 8A and 8B. FIG. 8A is a plan view of a drain wiring and a gate wiring to a pixel electrode, and FIG. 8B is a plan view of the drain wiring to a common electrode of the topmost layer. The fourth embodiment is an embodiment in which an organic insulating film on the drain wiring and the gate wiring is left and most of the organic insulating film inside a pixel is removed.

An organic insulating film 55 having a film thickness of about 2 μm is patterned and left above a drain wiring 30 and a gate wiring 35 on a TFT substrate 10 made of transparent glass for annealing, and a tilt angle θ at the end portion of the organic insulating film 55 is then formed at an angle of about 50 degrees. A transparent pixel electrode 60 is electrically connected to a source electrode 42 of a TFT through a contact hole 45 on the organic insulating film 55. The pixel electrode 60 is patterned in a gap of about 2 μm to the adjacent pixel electrode on the boundary portion to the adjacent pixel on the drain wiring 30. An interlayer insulating film 70 made of an inorganic film having a uniform thickness of about 150 nm is formed on the pixel electrode 60, and a transparent common electrode 80 including a stripe slit 85 in a width of 3 μm is formed on the interlayer insulating film 70. In the embodiment, as illustrated in FIG. 8B, the stripe slit 85 of the common electrode 80 is formed in such a way that the end portion of the slit 85 is located on the slope portion of the organic insulating film 55 at a slight angle in the upper half portion and in the lower half portion in the lateral direction. The rotation directions of liquid crystals are reversed in the upper half portion and in the lower half portion, so that it is suppressed that colors are changed due to viewing angles in top, bottom, left, and right directions.

Also in the embodiment, as similar to the first embodiment, most of the organic insulating film 55 in the display region including the contact hole 45 connected to the source electrode 42 is removed, so that the area of the contact hole 45 can be reduced. Accordingly, the light shielding area of the contact hole can be reduced, the pixel aperture ratio can be increased, and the transmittance can be improved.

Moreover, the organic insulating film is left on the wiring region of the drain wiring and the wiring region of the gate wiring, that is, the organic insulating film is left on the boundary region, so that the gap of the pixel boundary is narrowed, and the leakage of liquid crystals from the liquid crystal domain to the pixel adjacent to the domain caused by the elasticity effect of liquid crystals is suppressed. Thus, color mixing with the adjacent pixel can be suppressed, and a black matrix BM provided on a color filter substrate can be formed in narrow lines, which in turn enables the deletion of the black matrix BM.

Furthermore, as illustrated in the enlarged plan view in FIG. 7, a gap of a liquid crystal cell is reduced on the end portion of the comb teeth electrode, that is, a gap of a liquid crystal cell is reduced on the end portion of the stripe slit of the common electrode. Thus, a drive voltage can be increased, the production of a reverse rotation domain can be suppressed, and a reduction in the transmittance caused by the reverse rotation domain of liquid crystals can be suppressed.

### Fifth Embodiment

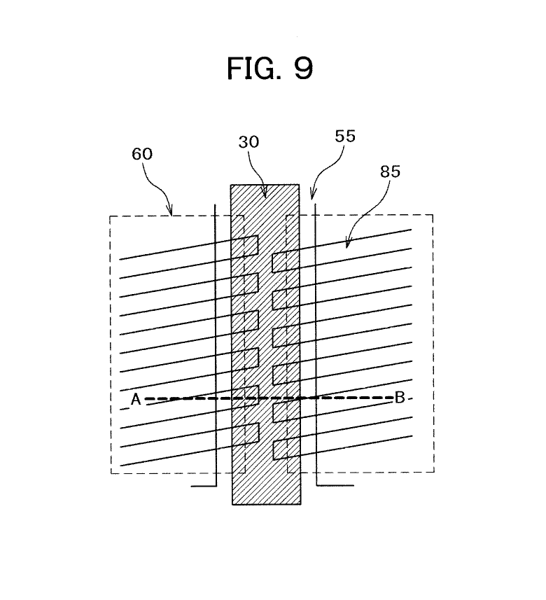

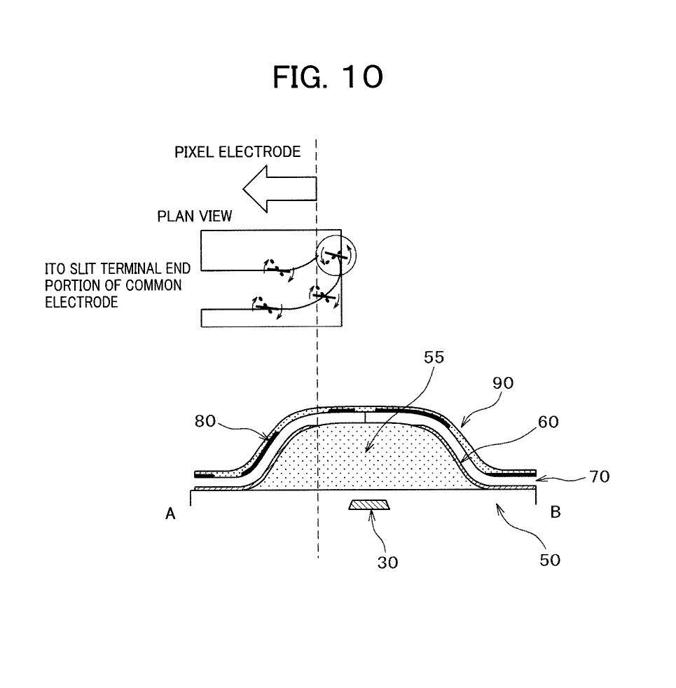

FIGS. 9 and 10 illustrate a liquid crystal display device according to a fifth embodiment. FIG. 9 is a plan view of the vicinity of the boundary between two adjacent pixels, and FIG. 10 is a cross sectional view along a line A-B near the boundary between the pixels in FIG. 9. The fifth embodiment is an embodiment in which such a structure is provided that a pixel electrode is not provided immediately below the end portion of the stripe slit of a common electrode in the liquid crystal display device according to the first embodiment.

In FIGS. 9 and 10, an organic insulating film 55 is formed above a drain wiring 30, and a pixel electrode 60 is formed on the organic insulating film 55. A common electrode 80 is formed on the pixel electrode 60 through an interlayer insulating film 70.

In the embodiment, particularly, the common electrode 80 is disposed in such a way that the length of a stripe slit 85 of the common electrode 80 is stretched and the common electrode 80 is not overlapped with the pixel electrode 60 immediately below at the terminal end portion of the stripe slit 85.

According to the embodiment, in addition to the effect in the first embodiment, since there is no pixel electrode at the terminal end portion of the stripe slit, no fringing field is produced at the terminal end portion of the slit, and the rotation of liquid crystals does not occur. Thus, the production of the reverse rotation domain at the end portion of the comb teeth electrode can be further suppressed, and a reduction in the transmittance of a display pixel can be suppressed. Moreover, the configuration of deposing the electrodes near the boundary of the adjacent pixels obtains the highest effect of improving the transmittance in the case where the configuration is implemented on drain wirings on both sides of a green pixel, which dominates a visual appreciation transmittance. Furthermore, in this case, the terminal end portion of the stripe slit electrode is provided on drain wirings adjacent to a blue pixel and a red pixel, so that the stripe electrodes can be electrically connected, and the potentials of the stripe electrodes can be stabilized.

### Sixth Embodiment

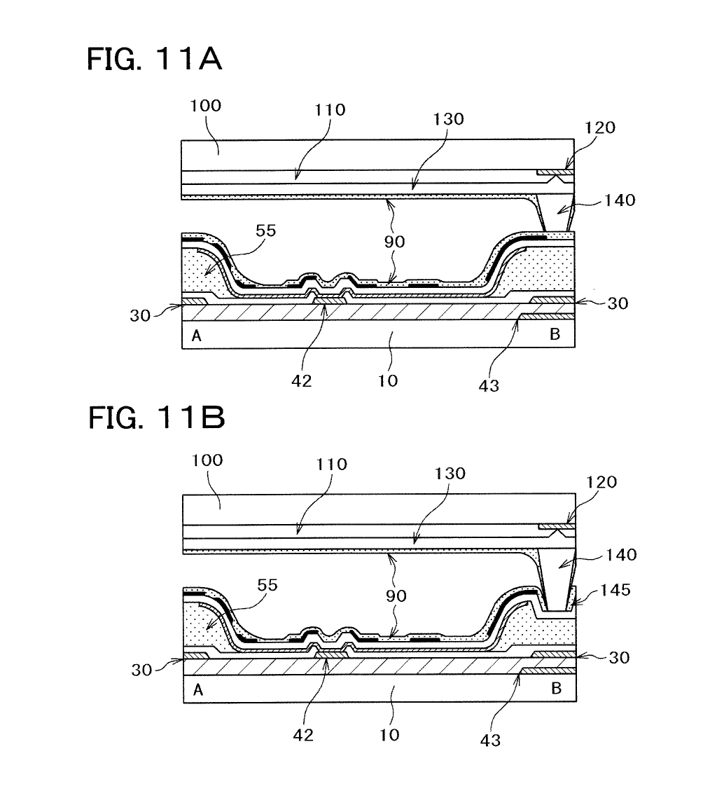

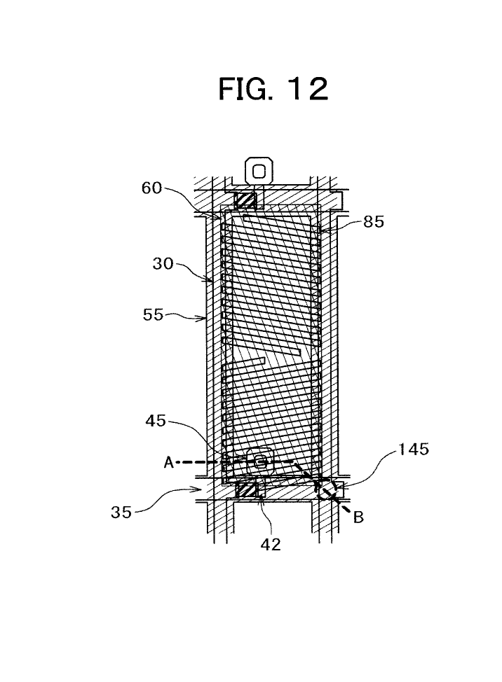

FIGS. 11A and 11B and FIG. 12 illustrate a liquid crystal display device according to a sixth embodiment. FIG. 12 is a plan view of a single pixel, and FIGS. 11A and 11B are cross sectional views of the pixel along a line A-B in FIG. 12. The sixth embodiment is an embodiment in which a cylindrical spacer is provided to stabilize a cell gap in the liquid crystal display device according to the fourth embodiment.

In an embodiment illustrated in FIG. 11A, a projecting cylindrical spacer 140 is formed on a counter substrate (a color filter CF substrate) 100 side so as to overlap with an organic insulating film 55 on a TFT substrate 10, and the cell gap of a liquid crystal layer is held using the organic insulating film 55 and the cylindrical spacer 140. It is noted that as illustrated in FIG. 12, the cylindrical spacer is provided on a drain wiring or a gate wiring, and a single cylindrical spacer is provided per a plurality of pixels, for example.

According to the embodiment, such an effect is exerted that the liquid crystal cell gap can be stabilized, in addition to the effect that the pixel aperture ratio is increased and the transmittance is improved as in the fourth embodiment. Particularly, a cylindrical spacer is conventionally formed on a counter substrate (a color filter CF substrate) and provided so as to contact a flat place such as a drain wiring and a gate wiring. However, the cylindrical spacer is provided at a location overlapped with the organic insulating film, so that the height of the cylindrical spacer can be reduced, and manufacture can be facilitated.

In an embodiment illustrated in FIG. 11B, a base recess 145 formed of a hollow or a groove is formed at a location on an organic insulating film 55 corresponding to a projecting cylindrical spacer 140 formed on a counter substrate 100 in such a way that the projecting cylindrical spacer 140 is filled in the base recess 145.

According to the embodiment, the base recess in which the cylindrical spacer is filled exerts the effect that misalignment between the upper substrate and the lower substrate can be prevented, in addition to the effect in the embodiment in FIG. 11A.

Moreover, also in the liquid crystal display device according to the first embodiment, such effects can be obtained that the liquid crystal cell gap can be stabilized and that misalignment between the upper location and the lower location can be prevented using the cylindrical spacer as in FIG. 11A or FIG. 11B for stabilizing the cell gap as described above. However, the cylindrical spacer is combined with a projecting cylindrical spacer formed on the counter substrate 100 in such a way that the projecting cylindrical spacer is formed to contact a flat place on the gate wiring with no organic insulating film on the opposite TFT substrate 10, so that the stabilization of the liquid crystal cell gap can be further improved.

### Seventh Embodiment

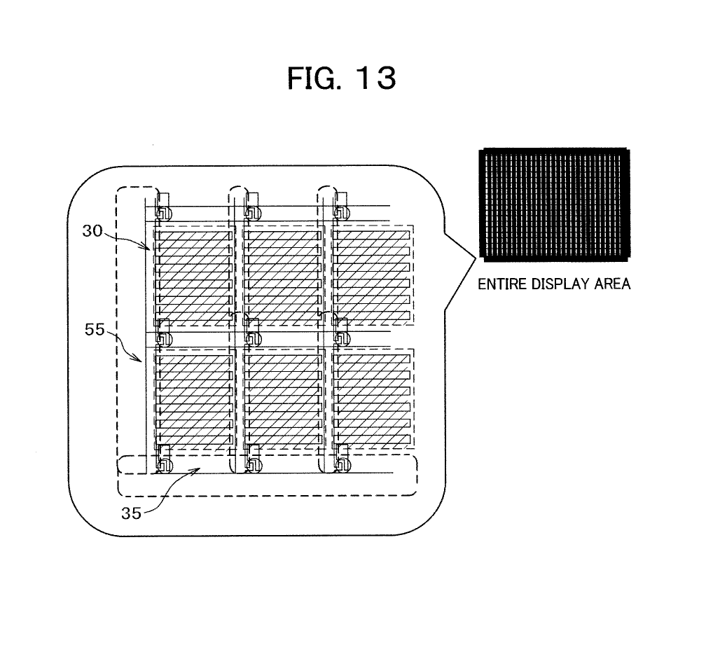

FIG. 13 is a liquid crystal display device according to a seventh embodiment. FIG. 13 is an enlarged plan view of a single corner of the entire display area of the liquid crystal display device. The seventh embodiment is an embodiment having a structure in which an organic insulating film is formed in a bank shape throughout the outer edge of a display region to entirely surround the display region.

In the embodiment, an organic insulating film 55 is formed in a bank shape on a drain wiring 30. The organic insulating film 55 is then formed in a bank shape also on a gate wiring 35 on the outer edge of the display area of a TFT substrate in addition to on the drain wiring 30. The pattern width of the organic insulating film on the outer edge is formed wider than the pattern width inside a pixel. Thus, an alignment layer is not leaked out in applying and forming the alignment layer by printing or ink jet, for example, and accuracy on the edge can be improved.

Moreover, the pattern of an organic insulating film is formed in a bank shape also on the outer edge of the display area of a counter substrate in forming a cylindrical spacer on the counter substrate, so that accuracy on the edge can be improved in applying and forming the alignment layer by printing or ink jet, for example.

What is claimed is:

1. A liquid crystal display device in a lateral electric field mode comprising:
a metal wiring formed on a transparent substrate;
an inorganic insulating film and an organic insulating film formed on the metal wiring; and
a first transparent electrode and a second transparent electrode having a stripe slit structure formed on the inorganic insulating film and the organic insulating film so that the first transparent electrode and the second transparent electrode are opposite to each other through an interlayer insulating film, liquid crystals being driven by applying an electric field across the first electrode and the second electrode, wherein:
an output from a thin film transistor is electrically connected to the first transparent electrode or the second electrode through a contact hole penetrating through the inorganic insulating film or the organic insulating film;
a film thickness of the organic insulating film on the metal wiring is made thicker than a film thickness of the organic insulating film on a pixel display region including the contact hole, and a projecting portion of the organic insulating film is formed on the metal wiring; and
a pixel electrode formed of the first electrode or the second electrode is formed on an image display region including a slope portion of the projecting portion.

2. The liquid crystal display device according to claim 1,
wherein the metal wiring is any one of a drain wiring and a gate wiring or both of the drain wiring and the gate wiring.

3. The liquid crystal display device according to claim 1,
wherein the organic insulating film is not formed on a contact hole formed at least on the pixel display region.

4. The liquid crystal display device according to claim 1,
wherein an area of the covering organic insulating film formed at least on the pixel display region is 50% or less of an area of the display region.

5. The liquid crystal display device according to claim 1, wherein:
an alignment layer is provided on the second transparent electrode or the first transparent electrode; and
the alignment layer is an optical alignment layer.

6. The liquid crystal display device according to claim 1,
wherein a terminal end portion of a slit of the second transparent electrode is formed on the organic insulating film.

7. The liquid crystal display device according to claim 6,
wherein the second transparent electrode is not overlapped with the first transparent electrode immediately below at the terminal end portion of the stripe slit of the second transparent electrode.

8. The liquid crystal display device according to claim 1,
wherein a tilt angle of the projecting portion of the organic insulating film on the metal wiring is an angle of 10 degrees or more and an angle of 75 degrees or less, more preferably, an angle of 10 degrees or more and an angle of 50 degrees or less.

9. The liquid crystal display device according to claim 1,
wherein the organic insulating film on the metal wiring is colored.

10. The liquid crystal display device according to claim 1, wherein:
the first transparent electrode is a pixel electrode; and
the second electrode having a stripe slit structure is a common electrode.

11. The liquid crystal display device according to claim 10, wherein:
a transparent common electrode having a stripe slit structure is formed in a direction nearly orthogonal to a drain wiring;
a slit end portion is not disposed on a green pixel; and
a terminal end portion of a slit is formed on a drain line adjacent to a blue pixel and a red pixel.

12. The liquid crystal display device according to claim 1, wherein:
the first transparent electrode is a common electrode; and
the second electrode having a stripe slit structure is a pixel electrode.

13. The liquid crystal display device according to claim 1,
wherein a light shielding portion is not formed between adjacent pixels at a location on a counter substrate corresponding to the projecting portion of the organic insulating film.

14. The liquid crystal display device according to claim 1, wherein:
a projecting cylindrical spacer is formed on a counter substrate side so that the projecting cylindrical spacer is overlapped with the projecting portion of the organic insulating film on a TFT substrate; and
a cell gap of a liquid crystal layer is held using the projecting portion of the organic insulating film and the cylindrical spacer.

15. The liquid crystal display device according to claim 14,
wherein at the location on the organic insulating film on the TFT substrate corresponding to the projecting cylindrical spacer, a base recess formed of a hollow or a groove is formed so that the projecting cylindrical spacer is filled in the base recess.

16. The liquid crystal display device according to claim 1,
wherein a structure is provided in which the organic insulating film is formed in a bank shape throughout an outer edge of a display region to entirely surround the display region.

17. The liquid crystal display device according to claim 16,
wherein a width of the organic insulating film formed in a bank shape throughout the outer edge is wider than a width of the projecting portion of the organic insulating film in the display region.
